(19) United States
(12) Patent Application Publication
(10) Pub. No.: US 2019/0191723 A1
(43) Pub. Date: Jun. 27, 2019

(54) Method of Making Frozen Dough and Products Made Using The Method

(71) Applicant: Rongxuan Cai, Sioux Falls, SD (US)

(72) Inventor: Rongxuan Cai, Sioux Falls, SD (US)

(21) Appl. No.: 15/855,489

(22) Filed: Dec. 27, 2017

(51) Int. Cl. A21D 10/02; A21D 6/00; A21D 8/04

(52) U.S. Cl. CPC A21D 10/02; A21D 8/04; A21D 6/001

(57) ABSTRACT

The present invention discloses a method for the preparation of ready-to-cook frozen dough products. The method comprises preparing a dough made of flour, water and yeast, and optional additives; portioning the dough to product sizes; making up the dough to desired sizes, shapes and ornamental configurations; freezing the dough; subjecting the dough to at least one freeze-thaw cycling; and refreezing the dough. Dough products are cooked directly from their frozen states to produce finished goods. Dough and cooked articles using the present invention have quality characteristics comparable to those made using conventional fermentation and proofing prior to cooking.

### FIELD

The present invention relates to frozen dough product and method for making the same. In particular, the present invention relates to methods of making frozen dough using freeze-thaw cycling. The present invention further relates to frozen dough products that are uncooked and that have undergone at least one freeze-thaw cycling before being re-frozen. The present invention also relates to bakery products that are cooked from the frozen dough made using the method of present invention.

### BACKGROUND

Bread is a staple food in majority population of the world. Bread can take on different sizes and shapes. Pound loaves are typically sliced to use for sandwiches, while buns can take several forms such as dinner rolls, sandwich buns and hot dog buns. French bread typically has a very crispy crust and can come with a variety of flavors. Ciabatta and Focaccia are other types of breads that are originated from Italy and play a significant role in people's daily diets in Europe and are nowadays becoming popular in the United States. Breads are typically evaluated based on the color, texture, cell openings, and symmetry of the products.

Breads are also stuffed to form pocket breads, burritos, pouches, and topped in the case with pizza type products. Flat bread can also be used to produce a variety of products, e.g. as bakeries with and without toppings. Both raw and baked bread types are available in the market. Bakeries can be shelf-stable and consumed at any time of the day, or can be frozen and reheated prior to consumption. Raw dough products must be cooked before consumption. Preparation of raw dough by any cooking methods adds a step of preparation, but preparation from the raw dough prior to consumption makes the product fresher compared to baked products that could have undergone staling during storage and consequently lose the freshness. Additionally, stuffed raw dough has the benefit of keeping the filling fresh right out of the oven since the filling will only receive one final time of heating before consumption if it comes with a raw dough. It would have received multiple times of heating if it comes with a baked dough. Typically, repeated heat treatments will damage fillings, especially for those that have a tender texture, such as fruits and vegetables. Therefore, there is a desire to produce frozen raw dough and cook the dough just prior to consumption. While this can be done without difficulties for some flat bread type products, it has been challenging when trying to produce a raw bread dough that can be baked directly from frozen state. All current frozen raw doughs need a resting step for 2-4 hours before baking, and cannot produce an acceptable product when baked directly from frozen state. As mentioned, it is time consuming if a resting step is used prior to cooking, and there is a loss of freshness if the products are baked and reheated multiple times before consumption.

Hard wheat flours are required to make quality bread. While hard red spring flours are more suitable for hearth loaf bakery and for frozen dough application where a higher gluten strength is desirable, hard red winter flours are more suitable for artisan breads with crispy crusts, and a desirable texture and flavor. The flour has a suitable gluten strength which is not too strong but enough to create the artisan texture and flavor. Hard red spring wheat flours are generally too strong to produce desirable artisan texture.

Another type of major bread product is the steamed breads that have been consumed as a staple food in Asian countries since ancient times. In contrast to breads in the US and many Western Countries, the steamed bread has similar dough mixing, make up, fermentation, and proofing procedures but instead of baking, the steamed bread is prepared by steaming a dough in the head space of an enclosed container filled with steam generated from boiling water.

Fresh steamed bread is prepared by mixing the dough, portioning the dough to product sizes, fermenting and proofing the dough, and steaming the dough immediately after proofing. The product of steamed bread is evaluated by a white and smooth shinny skin, uniform cell opening, and a soft but chewy bite when eating.

Soft wheat flour and hard winter wheat flour have been used in steamed bread but not hard red spring wheat flour. It was found that the gluten strength in the soft wheat flour had a positive effect on the steam bread quality, whereas high gluten strength in hard wheat flour, especially in hard red spring wheat flour had negative effect on the same steamed bread quality. Gluten strength is important for the soft wheat flour in dough making by enhancing gas holding ability. In contrast, excessive gluten strength in hard wheat flour could result in shrinkage during dough and finished product preparation. As a result, low volume and wrinkles may occur, giving rise to a poor steamed bread quality.

There are two major types of steamed bread in the majority of Asian countries, steamed bread as a staple food where no sugar is added and steamed bread as a dessert where sugar is added. In northern China, steamed bread is commonly consumed as a staple food, and the bread is made with a middle to low gluten flour with a protein content of about 9-10.5%. Sugar is not used in the steamed bread. In southern China, steamed bread is used as a dessert, sugar as well as oil and shortening are added in dough.

The differences in the formulation and the way of preparation using steam and conventional oven result in very different texture and flavor characteristics for the end products. Bakery products like pound breads, dinner rolls, buns, flat breads and bagels have a formula utilizing hard wheat flours. Both hard red spring and hard red winter wheat flours have been used. Soft wheat flours are generally unsuitable to produce bread but are suitable for pastry, cake, and cookie applications. In contrast, steamed bread requires a medium to low gluten strength. Both soft wheat flour and hard red winter wheat flour are used to produce steamed bread. Hard red spring flours are too strong to produce steamed bread and generally will require a blending with soft wheat flour and/or with the addition of other bulking agent, like starch, protein to dilute the gluten before it can be used for steamed bread applications.

Breads generally undergo moisture loss during baking. Depending on the baking temperature and time, the moisture loss can be somewhere between 2-20%. Steamed bread, on the other hand, will have a gain in moisture after steaming. Steamed bread will have a moisture increase of about 1-3% after steaming. Depending on the size of the product, a steaming time of 10-20 min is generally sufficient to cook the bread to a fully cooked product. The differences in moisture content make the steamed bread very different in texture and mouth feel from those of the breads. Those who consume artisan breads in their culture will find the steamed bread to be wet and gummy. In contrast, those who consume steamed bread in their culture will find baked bread to be dry and chewy.

Baked breads are evaluated based on their color, texture and cell openings. The eating quality of baked bread are characterized by crispiness, tenderness, chewiness, resilience and softness, and the requirements of these characteristics could be different for different products. For example, a pound bread slice should be tender and soft. On the other hand, an oven hearth bread should have a hard crispy crust with a chewy inner texture. In fact, a texture like the pound bread slices will be considered not chewy enough to be used as a hearth bread. A pizza crust will typically require a tender inner texture and a crispy outside texture. In contrast, steamed breads are evaluated based on a shiny white skin, a uniform small cell openings, and a chewy texture. Because of the differences in method of preparation and quality requirements, formulas for baked breads are not always applicable to the steamed breads. The specific volume of a steamed bread is typical in the range of 3-4 mL/g whereas the specific volume of a baked bread could be as high as 5-6 mL/g. Since it is less important for large open cell structures, steamed breads do not required strong gluten in flour to develop the air cell structure. Additionally, a strong flour will result in collapse of the steamed breads. All purpose flour can be used to make both baked breads and steamed breads.

Freezing technology has enabled food to be preserved longer than without the freezing technology, and has offered convenience to consumers. Frozen dough has enjoyed much progress in offering both longer shelf-life and convenience, and has brought extreme broad spectra of products. Frozen dough product nowadays ranges from raw, to par-baked or baked products, from chemical leavened dough to yeast leavened dough, from white flour based dough to whole grain based dough, from wheat flour based dough to other grains, including corn, sorghum and other ancient grains. Countless varieties of frozen dough products can be found in the market. Examples include, raw bread frozen dough, buns, bagels, croissant, ciabatta, Focaccia, flatbread, pizza crusts, and the like. Consumers have been enjoying quality products out of frozen dough, and have been relying on processed ready-to-cooked frozen dough products since skills used to be required in making these products are no longer needed.

While there are choices for raw frozen dough products in baked bread platform, such as those using a hour long resting and fermentation procedure, there is a desire to produce ready-to-cook frozen dough so that long hours of resting and fermentation are no longer required. There is a lack of ready-to-cook raw frozen dough for various bread platforms. Such a product series can include all types of bread based products, including but not limiting to bread, buns, ciabatta, Focaccia, stuffed breads, steamed bread, mantou, buns, baobun, steamed baobuns (steamed bread with fillings) and the like. There is a need for the development of a raw frozen dough that can be cooked directly from its frozen state. This invention discloses a method to produce raw dough that can be cooked from frozen state.

### SUMMARY

The present invention discloses a method to produce frozen dough that is raw and that can be cooked directly from frozen state. According to some embodiments of the invention, method of preparing the ready-to-cook raw frozen dough comprises mixing a dough composed of flour, water and yeast, and optionally salt, sugar and other food additives, portioning the dough to desired sizes, making up the dough to desired shape, form, and ornamental designs, freezing the dough, subjecting the dough to at least one freeze-thawing cycling, and re-freeze the dough. This invention further discloses raw and cooked articles prepared using the method of the present invention, including articles cooked from frozen dough of present invention using baking, steaming, frying and microwaving.

### BRIEF DESCRIPTION OF DRAWINGS

FIGS. 1A, B, and C show the comparative images of (A) bread bun produced by baking a frozen dough without fermentation or proofing and without freeze-thaw treatments; (B) bread bun produced by a standard bread making procedure in which the frozen dough was thawed, fermented and proofed immediately prior to baking; and (C) bread bun produced by an embodiment of present invention.

FIGS. 2A, B, and C show the comparative images of (A) steamed breads produced by steaming a frozen dough without fermentation or proofing and without freeze-thaw treatment; (B) steamed bread produced by a standard procedure of steamed bread making in which the frozen dough was thawed, fermented and proofed prior to steaming; (C) steamed bread produced by embodiments of present invention.

### DETAILED DESCRIPTION

The present disclosure relates to frozen dough products and method of making the same. The present invention further relates to ready-to-cook frozen dough products and method of making the ready-to-cook frozen dough products. In particular, the present invention relates to method to produce bread, steamed bread, fried bread and microwaved bread frozen dough products that are raw and that are capable of being cooked directly from frozen state to produce a finished product for consumption. According to embodiments of present invention, the method of preparation comprises a step of subjecting a frozen dough product to at least one freeze-thaw cycling prior to re-freeze the dough and storing the dough products at frozen conditions.

The term “freeze-thaw cycle” or “freeze-thaw treatment” is used here to refer to a treatment to the dough which is defined as having the dough undergo at least one ice-to-water phase change in dough starting from a frozen state, thawing and then returning to completely frozen state. The term “freeze-thaw cycling” is used here to refer to the process of conducting a “freeze-thaw cycle” by changing the dough temperature. According to embodiments of the present invention, the dough temperature can be changed by bringing the dough from frozen state (−40° F. to 30° F.) to a thawed state in a cooler (34° F. to 40° F.), at cold manufacture conditions (from 50° F. to 65° F.), or at countertop in room temperature (around 65° F. to 80° F.), or at elevated temperature in a fermentation or a proof room or cabin (e.g. 80° F. to 110° F.) for a time ranged from a few minutes to several hours until the size of the product is about double. It is generally understandable that at a lower temperature, a longer time is required and vice versa. In some embodiments of present invention, microwave energy is used to assist in causing a temperature change more efficiently and to shorten the time of the freeze-thaw cycling. Dough in a frozen state could be thawed using microwave energy assistance in the low energy defrosting or thawing model.

The term “negative control” is used herein to refer to samples that were prepared without using the present invention but cooked directly from frozen state as what is done for the present invention.

The term “positive control” is used herein to refer to samples that were prepared using a full fermentation and proofing prior to cooking.

The term “about” is used here to indicate variations in measurement as expected by persons skilled in art and is understood to cover a typical margin of error such as ±5% of the stated value.

Frozen raw food materials normally require some treatments before the materials can be cooked for consumption. Raw dough can be warmed up and fermented or proofed before baking. When a raw dough is thawed, fermented and proofed before baking, a higher quality of a finished product will normally result, compared to a finished product that is baked directly from frozen status. However, additional preparation steps are often time consuming and take away the conveniences that consumers will enjoy if the frozen food were cooked right from the freezer without having to thawing, resting, fermenting or proofing. For example, a resting time of 3-4 hours is normally required for a frozen dough ball to double in volume and be ready to bake. According to embodiments of the present invention, dough made using the method of the present invention can be cooked directly from the frozen state, and food articles prepared using the present invention have a product quality comparable to known prior arts.

One option to shorten or eliminate the preparation time prior to cooking frozen food items is to complete these steps before freezing. For example, a dough can be proofed before freezing, thereby, eliminating the hour long proofing step at the point of cooking. The challenge is that a proofed dough is more vulnerable to freezing damage than a dough without proofing. In addition, the gas holding ability of a dough is limited and typically a dough will lose gas during the frozen storage, giving rise to a lower quality product at final cooking. Therefore, pre-proofing the raw dough, freezing, and baking directly from frozen state usually compromises product quality and their applications are limited to certain products that have low specific volumes after cooking.

Another option is to use chemical leaveners, or a combination of chemical leaveners and yeast. Dough is mixed like yeast leavening products, but chemical leaveners are added to the dough. Dough could be preproofed or not preproofed and frozen after makeup. Dough product is cooked directly from the freezer. Chemicals leaven the dough during baking due to carbon dioxide produced by the reaction of sodium bicarbonate with a leavening acid, such as sodium acid pyrophosphate, sodium aluminum phosphate, mono calcium phosphate, glucono delta lactone, cream of tartar (potassium bitartrate), or citric acid. Products utilizing chemical leaveners will produce a texture of biscuit type. While yeast leavened products have larger and well-defined cell openings, chemically leavened breads possess grainy and dense textures with small air cell openings.

Depending on product types, a selected method could be useful for one type but not another. No all preproofed methods or chemical leavening methods can be applied to all types of products. Pre-proofing is typically not applicable to bread type products, such as loaves and buns. These products have a soft and tender texture and preproofing will result in issues in product handling. More importantly, these products typically have a very high specific volume (e.g. 5-6 mL/g), making it impossible to preproof the dough and keep the dough in a frozen state without altering the size and shape. Dough is typically damaged during frozen storage and collapsed during cooking. Similar challenges exist for dough products that are cooked directly from frozen regardless of the cooking methods used including baking, steaming, frying or microwaving.

In order to produce dough products that can be cooked directly from a frozen state, modifications are required for the dough. The dough needs to possess a rheological property that can expand during cooking without shrinking back. The dough also requires sufficient reservations in leavening actions so that enough gases can be produced to leaven the dough and increase the volume. The dough also needs to be in a geometrical property suitable for dimensional volume changes. For example, a flatbread can expect a two-dimensional volume changes, while a bun can expect three-dimensional volume changes during cooking. Small dough pieces will have a higher heat transfer efficiency compared to larger dough pieces, and products will expand and perform differently based on their sizes and shapes. According to embodiments of the present invention, the cooking performance of frozen dough products are enhanced when freeze-thaw cycling is used as a treatment to dough.

When a dough intended to be used as a ready-to-cook frozen dough is prepared using the traditional pre-proofing method or the combination of a yeast and chemical leavener agents, the dough is not performing to an acceptable bread quality. The common issues are a collapsed bread, wrinkles on the skin, loss of an attractive golden-brown color, or loss of a shiny smooth skin for some products. Instead, the skin is dull, grey and grainy like, and the texture is dense and gummy, with a low volume. The reasons are due to the damage effects that the freezing has on a preproofed product. The preproofed dough has an air cell structure that is susceptible to physical damage, and the dough, after being proofed, typically has poor gas-holding ability. In some cases, cooking a pre-proofed frozen dough is similar to cooking an over-proofed dough, which usually collapses during cooking. A dull, grey and grainy skin is observed when chemical leaveners are used and no proofing or a very small amount of proofing is used. The issue in the skin is likely due to the lack of leavening actions, especially the lack of leavening action from yeast.

It was discovered that when a ready-to-cook frozen dough undergoes a freeze-thaw cycle, the dough performs to an acceptable quality similar or close to the quality of a control product that is prepared by thawing, fermenting and proofing prior to baking or steaming Surprisingly, it was discovered that the collapsed phenomenon of a proofed dough during cooking can be prevented by instead of proofing, adding to the processed dough a freeze-thaw step with at least one freeze-thaw cycling. After adding a freeze-thaw cycling step to the dough, the frozen dough is greatly enhanced in cooking performance and the cooked product has a quality meeting the texture, volume and visual appearance of a finished product using various cooking mechanism such as baking, steaming, frying, and microwaving.

According to the embodiment of the present invention, common bakery ingredients are used in frozen dough preparation. A hard wheat flour is suitable for baked bread production and both hard and soft wheat flour are used for steamed bread production. However, a weaker hard wheat flour and a stronger soft wheat flour are more suitable for steamed bread production. All purpose flour is suitable for both baked and steamed bread making. White refined wheat flour and whole grain wheat flour can be used to prepare product of present invention. Grains other than wheat can also be used. Examples of common grains include wheat, oat, barley, rye, rice, corn, quinoa, millet, sorghum, triticale, amaranth, and buckwheat. Both gluten flour, including wheat, barley, rye and gluten free flour can be used. Examples of common gluten free flour are oat, rice, corn, quinoa, millet, sorghum, triticale, amaranth, and buckwheat. Ancient grains can also be used. Example of ancient grains include einkorn, kamut, spelt, black barley, red and black rice, blue corn; sorghum, teff, millet, quinoa, amaranth; buckwheat, or wild rice.

Various yeasts can be used for preparation of the frozen dough products using embodiments of present inventions. Commonly used yeasts include cream yeast (moisture content about 82%), compressed yeast (moisture content about 35%), frozen yeast (moisture content about 20%), active dry yeast (moisture content about 7%), instant yeast (moisture about 5%). Although various yeasts differ in moisture content and the granular form, all yeasts can be used in preparation of the frozen dough products.

Various chemical leaveners are also available for use in the preparation of the frozen dough products. Sodium bicarbonate is the most common leavening base available from general stores. When a low sodium product is desirable, potassium bicarbonate can be used in place of sodium bicarbonate. One or more leavening acids are used together with the sodium or potassium bicarbonate. Common leavening acids include sodium acid pyrophosphate, sodium aluminum phosphate, mono calcium phosphate, glucono delta lactone, cream of tartar (potassium bitartrate), citric acid etc. Encapsulated chemical leaveners can also be used in the preparation of frozen dough. For example, encapsulated forms of sodium bicarbonate, sodium acid pyrophosphate, sodium aluminum phosphate, mono calcium phosphate, glucono delta lactone, and citric acid are available from major food ingredient suppliers and can be used in the preparation of the frozen dough.

According to embodiments of the present invention, the dough is mixed using flour, water, yeast and optionally salt, sugar and other additives. When other ingredients are used, flour and dry ingredients are blended for 1 min at a dough mixer, e.g. a Kitchen Aid, or a Hobart mixer. Yeast and water are then added and the dough is mixed for 1-2 min in low speed (typically about 30-40 rpm) to hydrate the flour. The dough is then mixed at high speed (typically 80-120 rpm) for 4-10 min to develop the gluten structure. After mixing, the dough will have a cohesive, resilience and viscoelastic rheology, meaning it is flexible but not sticky, is deformable when forced, not plastic, and has enough elastic properties to support dough structure and enough viscous properties to trap gas and enhance gas holding ability. After mixing, the dough can proceed directly to make up without resting. Optionally, dough can rest for a short period of time. For example, dough can rest for 10-30 min before make up. During make up, dough is shaped, sheeted or compressed to form desired sizes, forms and ornamental designs, or certain configurations. Make up for the dough can take several sizes. For example, dough for mini bread can range from 100-200 g. Dough for steamed bread loaves and buns can range from 100-120 g. Dough for mini buns can range from 20-40 g. Dough can also be made in different forms and ornamental designs such as croissant, bagels, donuts, buns, and pound bread or mini breads. Gas cells will progressively grow after dough mixing. Gas nuclei generated from mixing will grow to form visible cells in dough during resting and make up. Gas cells growth is slow but steadily and is dependent of dough temperature and time. The dough can then be frozen.

Typically, dough products are frozen using a blast freezer in which a high fan speed is used thereby generating very high air velocity and enhancing heat transfer efficiency. Dough products will have a very high cooling rate in a blast freezer and therefore, undergo quick freezing. The blast freezer typically has a temperature of −20° F. to −30° F. Dough products are then stored at storage freezer. The storage freezer will typically maintain a temperature at 0° F. or below 0° F. Dough products are then subjected to a freeze-thaw cycling for at least one time. According to some embodiments, during freeze-thawing cycling, dough products are brought from the freezer to a temperature of 50-65° F., and allowed to thaw for several hours until the size of the dough products is about double of the original dough size. In some other embodiments of the present invention, the dough can undergo freeze-thaw cycling using a cooler at a temperature of 34-50° F. In some other embodiments, the dough can undergo a freeze-thaw at ambient temperature of 65-80° F. In some other embodiments, the dough can undergo freeze-thaw using a proofer at a temperature of 80-110° F. According to embodiments of the present invention, at least one freeze-thaw cycle is used to treat the dough in the present invention. In other embodiments of the present invention, multiple freeze-thaw cycles can be used to treat the dough. The dough is then refrozen after the freeze-thaw cycling.

### EXAMPLES

Various embodiments of the formulas and methods according to present invention were tested in the following examples. Common lab and industrial equipment were suitable for making the dough. A Kitchen Aid mixer was used in mixing, and a home freezer was used as the storage freezer. A conventional baking oven and a 5 quarters steaming pot were used in the cooking test. Dough was mixed by mixing dry ingredients first, including flour, and other dry additives such as salt, sugar, non fat dry milk, and chemical leaveners, if any, and then mixing in wet ingredients, including yeast, water, syrups and shortening. Dough was mixed by hydrating dough at low speed followed by gluten development at high speed. Ingredients used include frozen yeast, which is a semi-dry yeast with a moisture content of about 20%, and compressed yeast, which has a moisture content of about 65%.

### Example 1

Frozen dough products were prepared from dough formulas and methods of preparation according to embodiments of present invention, and quality of dough balls was compared.

Sample Preparation:

Dough formulations of about 1700 g each were prepared according to Table 1 using a stand mixer. Flour and dry ingredients were added and blended for 1 min prior to the addition of yeast and water. The content was mixed for 2 min at low speed, and 4 min at high speed. Dough was divided into 100 g dough pieces, and dough pieces were hand rounded into dough balls. The dough balls has a specific volume of about 1.3-1.5 mL/g. Dough balls after preparation were blast frozen to −20° F. and stored at −20° F. until applying treatments.

Treatments:

All samples except those of the test were transferred from −20° F. freezer at day 3 to 0° F. freezer and kept in 0° F. freezer until use. The test samples were treated with freeze-thaw cycling. During the freeze-thaw cycling treatment, the test samples were stored in the −20° F. freezer for 3 days, and then transferred from the freezer into room temperature in a covered container. The dough balls in the container were left at room temperature (70° F.) for 2 hours. During the thawing process, the size of the dough balls increased to about double the original size. The dough balls were then blast frozen and stored back in the −20° F. freezer overnight. The products was then transferred into a 0° F. freezer and stored until use.

All formulas made similar dough balls and there were no apparent differences in the color, stickiness or cohesiveness of dough except that the treated dough balls are larger than the other frozen dough balls that were not treated. Dough balls prepared were used in the following cooking tests in Examples 2, 3, 4, and 5.

TABLE 1
Dough Formulations

| | | | | | Formula C (Frozen | | | | Formula E | |
|---|---|---|---|---|---|---|---|---|---|---|
| | Formula A (High | | Formula B (Frozen | | Yeast & Chemical | | Formula D | | (Compressed Yeast & | |
| | Yeast) | | Yeast) | | Leaveners) | | (Compressed Yeast) | | Chemical Leaveners) | |
| Ingredient | Baker's % | Grams | Baker's % | Grams | Baker's % | Grams | Baker's % | Grams | Baker's % | Grams |
| Wheat flour | 100 | 1000 | 100 | 1000 | 100 | 1000 | 100 | 1000 | 100 | 1000 |
| Frozen yeast | 3 | 30 | 1 | 10 | 1 | 10 | | | | |
| Compressed yeast | | | | | | | 3 | 30 | 3 | 30 |
| Encapsulated | | | | | 0.18 | 1.8 | | | 0.18 | 1.8 |
| sodium | | | | | | | | | | |
| bicarbonate | | | | | | | | | | |
| Sodium | | | | | 0.15 | 1.5 | | | 0.15 | 1.5 |
| aluminum | | | | | | | | | | |
| phosphate | | | | | | | | | | |
| Shortening | 3 | 30 | 3 | 30 | 3 | 30 | 3 | 30 | 3 | 30 |
| Salt | 1.5 | 15 | 1.5 | 15 | 1.5 | 15 | 1.5 | 15 | 1.5 | 15 |
| Sugar | 6 | 60 | 6 | 60 | 6 | 60 | 6 | 60 | 6 | 60 |
| Corn syrup | 0.2 | 2 | 0.2 | 2 | 0.2 | 2 | 0.2 | 2 | 0.2 | 2 |
| Whey | 2 | 20 | 2 | 20 | 2 | 20 | 2 | 20 | 2 | 20 |
| Non fat dry milk | 2 | 20 | 2 | 20 | 2 | 20 | 2 | 20 | 2 | 20 |
| Ascorbic acid | 0.002 | 0.020 | 0.002 | 0.020 | 0.002 | 0.020 | 0.002 | 0.020 | 0.002 | 0.020 |
| Water | 59.5 | 595 | 59.5 | 595 | 59.5 | 595 | 59.5 | 595 | 59.5 | 595 |
| Total | 177.20 | 1772.02 | 175.20 | 1752.02 | 175.53 | 1755.32 | 177.202 | 1772.02 | 177.532 | 1775.32 |

### Example 2

Dough formulas were prepared according to embodiments of the present invention and quality of product was evaluated after baking. Frozen dough balls from Example 1 were stored at 0° F. for 2 weeks and then used for baking test and bakery quality evaluation.

Treatment:

A negative control was taken as the sample stored in freezer and transferred from the freezer directly to oven for baking without receiving any treatments prior to the baking. A positive control was prepared by thawing the dough balls at room temperature for 2 h in a covered container and then proofed for 30 min at 95° F. and 75% humidity immediately prior to baking. Therefore, the positive control was fermented and proofed before baking while the negative control was not treated prior to baking. The test sample of the present invention was the sample that has received freeze-thaw cycling treatments from Example 1, and was not fermented or proofed.

Baking Test.

A negative control, a positive control, and a test dough ball from Formulas A, B, C, D, and E, each from Example 1 were used in the baking test. The negative control was transferred directly from the freezer into the oven and baked at 400° F. for 20 min. The positive control was transferred from the proofer to the oven and was baked at 400° F. for 15 min. The test dough ball of the present invention was transferred from the 0° F. freezer into the oven and baked at 400° F. for 20 min. All breads after baking were allowed to cool down to room temperature for about 20 min. Bread weight and size were evaluated after cooling.

Results of the baked bread evaluations are given in Table 2. As can be seen from Table 2, it was observed that the specific volumes of the test bread products were much higher than the negative control, and close to the positive control. The results indicated that the present invention with freeze-thaw cycling makes the dough ball able to be baked directly from frozen state without having to thaw, ferment and proof. The results also indicated that the present invention using a freeze-thaw pretreatment produced a dough ball that had a quality similar to those using thawing, fermentation and proofing prior to baking. It was concluded that the present invention produced dough balls that could be directly baked from frozen state and had volume much better than the negative control without any treatments, and close to the positive control that was thawed, fermented and proofed prior to baking.

TABLE 2
Weight and Specific Volume of baked Bread of Present Invention Compared to A Negative Control
without Any Treatments and A Positive Control Produced Using A Fermentation And Proofing Procedure.

| | | | | | Formula C | | | | Formula E | |
|---|---|---|---|---|---|---|---|---|---|---|
| | | | | | (Frozen | | | | (Compressed | |
| | Formula | | Formula B | | Yeast & | | Formula D | | Yeast & | |
| | A (high | | (Frozen | | Chemical | | (Compressed | | Chemical | |
| | Yeast) | | Yeast) | | Leaveners) | | Yeast) | | Leaveners) | |
| | | Specific | | Specific | | Specific | | Specific | | Specific |
| | Weight | Volume | Weight | Volume | Weight | Volume | Weight | Volume | | Volume |
| Product ID | (g) | (mL/g) | (g) | (mL/g) | (g) | (mL/g) | (g) | (mL/g) | Weight (g) | (mL/g) |
| Frozen Dough Ball | 100 | 1.50 | 100 | 1.40 | 100 | 1.40 | 100 | 1.50 | 100 | 1.50 |
| Negative Control | 89 | 2.47 | 92.1 | 2.01 | 90.9 | 1.46 | 90.9 | 2.04 | 91.4 | 2.05 |
| Positive Control | 81 | 5.31 | 84 | 3.57 | 85.5 | 3.53 | 82.9 | 3.92 | 83.4 | 4.20 |
| Present Invention | 85.9 | 4.28 | 87.6 | 3.37 | 87.2 | 3.23 | 88.3 | 3.53 | 86.7 | 3.88 |

### Example 3

Dough formulas were prepared according to embodiments of present invention and quality of product was evaluated after steaming. Frozen dough balls from Example 1 were stored at 0° F. for 2 weeks and used for a steaming test and steamed bread quality evaluation.

Treatment:

A negative Control was transferred from the freezer to a steam pot without receiving any treatments prior to steaming. A positive control was also prepared. The positive control was treated by thawing the dough balls at room temperature for 2 h in covered containers, and then proofed for 30 min at 95° F. and 80% humidity, immediately prior to steaming. Therefore, the positive control was fermented and proofed before steaming while the negative control was not treated prior to steaming. The test sample of the present invention was the sample that received freeze-thaw cycling treatment from Example 1 and was not fermented or proofed.

Steaming Test.

A negative control, a positive control, and a test dough ball of Formula A, B, C, D and E from Example 1 were used in the steaming test. The negative control was transferred directly from the freezer into a steaming pot and steamed right from frozen state for 15 min. The positive control was transferred from the proofer into a steaming pot and steamed for 10 min. The test dough ball of the present invention was transferred from the 0° F. freezer directly into the steaming pot and steamed for 15 min. The steamed bread after steaming was allowed to cool down to room temperature for about 20 min. Steamed bread weight and volume were evaluated after cooling.

Results of the steamed bread evaluations were given in Table 3. It was observed that the specific volume of the test bread products of present invention were much higher than those of the negative control, and close to those of the positive control. The results indicated that the present invention with freeze-thaw cycling makes the dough ball able to be steamed directly from frozen the state without having to thaw, ferment or proof. The results also indicated that the present invention using a freeze-thaw cycling pretreatment produced a dough ball that had a quality similar to dough balls undergoing thawing, fermentation, and proofing prior to steaming. It was concluded that the present invention produced frozen dough that can be directly steamed from a frozen state and had a volume close to control that was thawed, fermented, and proofed prior to steaming.

TABLE 3
Weight and Specific Volume of Steamed Bread of Present Invention Compared to A Negative Control
without Any Treatments and A Positive Control Produced Using A Fermentation And Proofing Procedure.

| | | | | | Formula C | | | | Formula E | |
|---|---|---|---|---|---|---|---|---|---|---|
| | | | | | (Frozen | | | | (Compressed | |
| | Formula | | Formula | | Yeast & | | Formula D | | Yeast & | |
| | A (High | | B (Frozen | | Chemical | | (Compressed | | Chemical | |
| | Yeast) | | Yeast) | | Leaveners) | | Yeast) | | Leaveners) | |
| | | Specific | | Specific | | Specific | | Specific | | Specific |
| | Weight | Volume | Weight | Volume | Weight | Volume | Weight | Volume | | Volume |
| Product ID | (g) | (mL/g) | (g) | (mL/g) | (g) | (mL/g) | (g) | (mL/g) | Weight (g) | (mL/g) |
| Frozen Dough Ball | 100 | 1.30 | 100 | 1.30 | 100 | 1.40 | 100 | 1.40 | 100 | 1.50 |
| Negative Control | 108 | 2.31 | 108 | 1.39 | 107.4 | 1.40 | 108 | 1.39 | 107.6 | 1.39 |
| Positive Control | 102 | 3.48 | 103 | 2.91 | 100 | 3.00 | 102.8 | 3.31 | 101.8 | 3.63 |
| Present Invention | 102.6 | 3.51 | 100.8 | 2.78 | 100 | 2.80 | 101.6 | 2.95 | 100 | 3.20 |

### Example 4

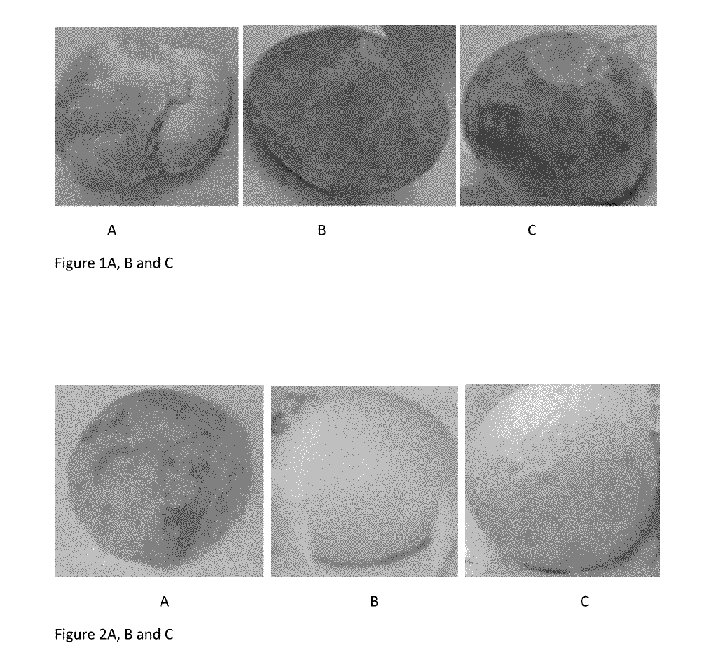

Samples from Formula E of Table 1 in Example 1 were stored for 4 weeks in a 0° F. freezer and then used for the evaluation of visual color and volume of products after baking. A negative control, a positive control and the test sample were prepared and baked as described in Example 2. Photos of baked products from Formula E are given in FIGS. 1A-C. As can be seen from FIGS. 1A-C, directly baking a frozen dough without treatments resulted in a dense dough mass with little leavening actions (negative control). Fermenting and proofing the dough immediately prior to baking produced the best product with a golden brown color and smooth surface, and with a good volume. When a freeze-thaw cycle was used as treatment, an acceptable bread quality was obtained which was much better than the negative control, and was comparable to the positive control. It was concluded that the present invention produced a bread close to the product of prior art using a full fermentation and proofing prior to baking.

### Example 5

Samples from Formula E of Table 1 in Example 1 were stored for 4 weeks in a 0° F. freezer and then used for the evaluation of visual appearance and volume of products after steaming. A negative control, a positive control and the test sample were prepared and steamed as described in Example 3. Photos of steamed products from Formula E are given in FIG. 2A-C. As can be seen from FIG. 2A-C, directly steaming a frozen dough without treatments resulted in a dense dough mass with gummy spots (negative control). Fermenting and proofing the dough immediately prior to steaming produced the best product with a shiny smooth surface and a good volume. The product also had a desired uniform cell openings. Results indicated that when a freeze-thaw cycling was used as treatments, an acceptable steamed bread was obtained which is much better than the negative control, and close in quality to the positive control. It was concluded that the present invention produced a steamed bread with an acceptable quality close to the product of prior art using a full fermentation and proofing prior to steaming.

While certain embodiments of the present invention have been described, other embodiments may exist. After reading the description herein, various aspects, embodiments, modifications, and equivalents may suggest themselves to one with ordinary skill in the art without departing from the spirit of the present invention or the scope of the claims.

I claim:

1. A method to prepare a frozen dough, the method comprising:
a. mixing the dough comprising flour, water, yeast, and optionally other food additives;
b. portioning and making up the dough to the desire size, shape and ornamental design.
c. freezing the dough;
d. subjecting the frozen dough to at least one freeze-thaw cycling; and
e. refreezing the dough.

2. Method of claim 1 where the dough is frozen in a freezer at temperature of 30° F. to −40° F., preferably 10° F. to −30° F., and more preferably 0° F. to −20° F.

3. Method of claim 1 wherein the dough undergoes one or more freeze-thaw cycles at any point of the frozen storage, preferably within the first 1 min to 30 days of frozen storage, more preferably within the first 1 hour to 10 days of frozen storage.

4. Method of claim 1, wherein during the freeze-thaw cycling, the dough is thawed for 1-72 hours at a temperature of 34-110° F. until the dough volume is about double of its original volume.

5. Method of claim 1, wherein the dough is refrozen at a freezer temperature below the freezing temperature of water from about 30° F. to about −40° F., and preferably at a temperature between 10° F. and −30° F., and more preferably 0° F. to −20° F.

6. The raw frozen dough products produced using method of claim 1, include but are not limited to raw bread dough, raw croissant dough, raw bagel dough, raw donut dough, raw pretzel dough, raw Ciabatta, raw Focaccia, raw sandwich buns, raw hamburger buns, raw hot dog buns. raw flatbread dough, raw pizza crust dough, raw pound loaf dough, raw mini bread dough, raw artisan bread dough, raw French bread dough, raw hearth loaves, raw buns, raw stuffed breads, raw baobun dough, raw potsticker dough, raw filled steamed bread dough, raw stuffed steamed bread dough, raw steamed bread dough, raw mantou, and the like.

7. A method to prepare cooked articles, the method comprising:
a. mixing the dough comprising flour, water, yeast, and optionally other food additives;
b. portioning and making up the dough to the desire size, shape and ornamental design;
c. freezing the dough such that the dough is frozen and has a temperature between 30° F. and −40° F.;
d. subjecting the frozen dough to at least one freeze-thaw cycling;
e. refreezing the dough; and
f. cooking the dough to a finished product for consumption.

8. Method of claim 7, wherein cooking comprises baking, steaming, frying, microwaving, or a combination thereof.

9. Cooked articles produced using method of claim 7, include but not limited to bread, croissant, bagel, donut, pretzel, Ciabatta, Focaccia, sandwich buns, hamburger buns, hot dog buns. flatbread, pizza crust, pound loaves, mini bread, artisan bread, French bread, hearth loaves, buns, stuffed breads, baobuns, potstickers, filled steamed bread, stuffed steamed bread, steamed bread, mantou, and the like.

10. Baked products produced using the method of claim 7.

11. Steamed products produced using the method of claim 7.

12. Fried products produced using the method of claim 7.

13. Microwaved products produced using the method of claim 7.
